(19) United States
(12) Patent Application Publication
(10) Pub. No.: US 2025/0347942 A1
(43) Pub. Date: Nov. 13, 2025

(54) LIQUID CRYSTAL DISPLAY DEVICE FOR DIRECTIONAL LIGHT

(71) Applicant: Liqxtal Technology Inc., Tainan City (TW)

(72) Inventors: Hung-Shan CHEN, Tainan City (TW); Sung-Nan CHEN, Tainan City (TW); Guo-Lin HU, Tainan City (TW)

(21) Appl. No.: 18/663,008

(22) Filed: May 13, 2024

(51) Int. Cl. G02F 1/13; G02F 1/1335

(52) U.S. Cl. CPC G02F 1/1323; G02F 1/133509; G02F 1/133528

(57) ABSTRACT

A display device includes a backlight module, a liquid crystal display panel, a viewing control film, and a light redirecting film. The backlight module is configured to provide a light. The liquid crystal display panel includes a liquid crystal layer, a first polarizer at a first side of the liquid crystal layer facing the backlight module, and a second polarizer at a second side of the liquid crystal layer facing away from the backlight module. The first polarizer is an absorptive polarizer. The viewing control film is between the backlight module and the liquid crystal display panel and configured to limit an angle of the light. The light redirecting film is between the viewing control film and the liquid crystal display panel and configured to redirect the light from the viewing control film to a target region.

### BACKGROUND

### Field of Invention

The present disclosure relates to a display device.

### Description of Related Art

Liquid crystal display panels have advantages of thinness, shortness, and energy conservation, and have been widely applied to various electronic products and portable electronic productions, for example, televisions, desktop computers (Desktop PC), smart phones, notebooks, and tablet computers (Tablet PC). As the liquid crystal display panel technology develops and people care more about privacy, the anti-peeping technology for liquid crystal display panels gains more attentions, and the industry spares no effort to study the anti-peeping technology for the liquid crystal display panels. Therefore, how to produce a liquid crystal display panel on which a visual angle can be adjusted to provide an anti-peeping function is a research urgently to be studied currently.

### SUMMARY

According to some embodiments of the present disclosure, an absorptive polarizer is on a side of the liquid crystal display panel facing the backlight module. The absorptive polarizer can effectively absorb ineffective polarized light. Through the configuration, the light reflection in the entire device can be reduced, thereby prevent components from heating up by absorbing light energy, which can improve the light-emitting efficiency of the entire display device.

In some embodiments of the present disclosure, a liquid crystal display device includes a backlight module, a liquid crystal display panel, a viewing control film, and a light redirecting film. The backlight module is configured to provide a light. The liquid crystal display panel includes a liquid crystal layer, a first polarizer at a first side of the liquid crystal layer facing the backlight module, and a second polarizer at a second side of the liquid crystal layer facing away from the backlight module. The first polarizer is an absorptive polarizer. The viewing control film is between the backlight module and the liquid crystal display panel and configured to limit an angle of the light. The light redirecting film is between the viewing control film and the liquid crystal display panel and configured to redirect the light from the viewing control film to a target region. In some embodiments, the second polarizer is a reflective polarizer.

In some embodiments, the second polarizer is another absorptive polarizer.

In some embodiments, wherein the angle limited by the viewing control film is in a range from about-30 degrees to about 30 degrees.

In some embodiments, wherein the angle limited by the viewing control film is in a range from about-10 degrees to about 10 degrees.

In some embodiments, the viewing control film is a privacy film.

In some embodiments, an off-axis absorbance of the viewing control film is greater than an on-axis absorbance of the viewing control film.

In some embodiments, the viewing control film is a liquid crystal angular attenuator filter.

In some embodiments, the liquid crystal display panel further comprises an active device array layer between the liquid crystal layer and the first polarizer, wherein the active device array layer comprises a plurality of active devices and a plurality of pixel electrodes electrically coupled to the active devices.

In some embodiments, the liquid crystal display panel further comprises a color filter layer at the second side of the liquid crystal layer facing away from the backlight module.

In some embodiments, the light provided by the backlight module scatters.

In some embodiments, the light redirecting film is a Fresnel lens.

In some embodiments, the light redirecting film is a micro-lens array.

In some embodiments, the light redirecting film is a liquid crystal lens.

In some embodiments, the light redirecting film is a geometric phase lens.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows.

FIG. 1 is a schematic cross-sectional view of a display device according to some embodiments of the disclosure.

FIG. 2A is a schematic cross-sectional view of an example of a viewing control film according to some embodiments of the disclosure.

FIG. 2B is a schematic cross-sectional view of an example of a viewing control film according to some embodiments of the disclosure.

FIG. 2C illustrates light intensity versus angle of a light before and after passing a viewing control film.

FIG. 3 is a schematic view of a liquid crystal display panel of the display device of FIG. 1.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

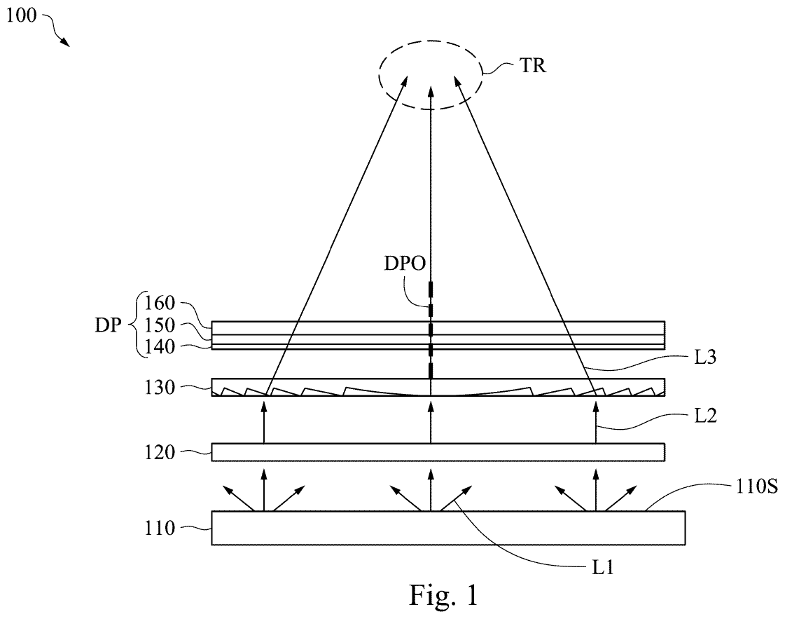

FIG. 1 is a schematic cross-sectional view of a display device 100 according to some embodiments of the disclosure. The display device 100 includes a backlight module 110, a liquid crystal display panel DP, a viewing control film 120, and a light redirecting film 130.

The backlight module 110 may be a direct light-emitting diode (LED) backlight module or an edge LED backlight module. The backlight module 110 is configured to provide light L1 with good uniformity and intensity. In some embodiments, the backlight module 110 has a light-providing surface 110S used to provide the light L1 having a highly scattered, essentially Lambertian distribution, and having an essentially constant luminance over a broad range of angles. The light L1 may be unpolarized or randomly polarized.

The viewing control film 120 is between the backlight module 110 and the liquid crystal display panel DP. The viewing control film 120 may be a passive film, such as a privacy film, or an active film, such as a liquid crystal angular attenuator filter. The viewing control film 120 is configured to restrict light for a determined angle by blocking a first portion of light deviating from the determined angle and passing a second portion of light adjacent to the determined angle. In some embodiments of the present disclosure, the viewing control film 120 is an absorptive element that absorbs a first portion of the light deviating from the determined angle and transmits the second portion of the light adjacent to the determined angle. For example, the viewing control film 120 may have a low transmittance (e.g., less than 5%) and a high absorbance (e.g., greater than 95%) away the determined angle, and a high transmittance (e.g., greater than 95%) and a low absorbance (e.g., less than 5%) at the determined angle.

In some embodiments, the determined angle of the viewing control film 120 is about-30 degree to about +30 degrees with respect to the optic axis. For example, the determined angle of the viewing control film 120 is about-10 degree to about +10 degrees with respect to the optic axis. In some embodiments, the viewing control film 120 restricts light for a range of off-axis angles by blocking/absorbing off-axis light and passing/transmitting on-axis light. Stated differently, an off-axis transmittance of the viewing control film 120 (e.g., outside −30 degree to about +30 degrees with respect to the optic axis, or outside-10 degree to about +10 degrees with respect to the optic axis) is less than an on-axis absorbance of the viewing control film 120 (e.g., inside-30 degree to about +30 degrees with respect to the optic axis, or inside-10 degree to about +10 degrees with respect to the optic axis). In some embodiments, the determined angle of the viewing control film 120 can be any desired degrees with respect to the optic axis depending on device requirement.

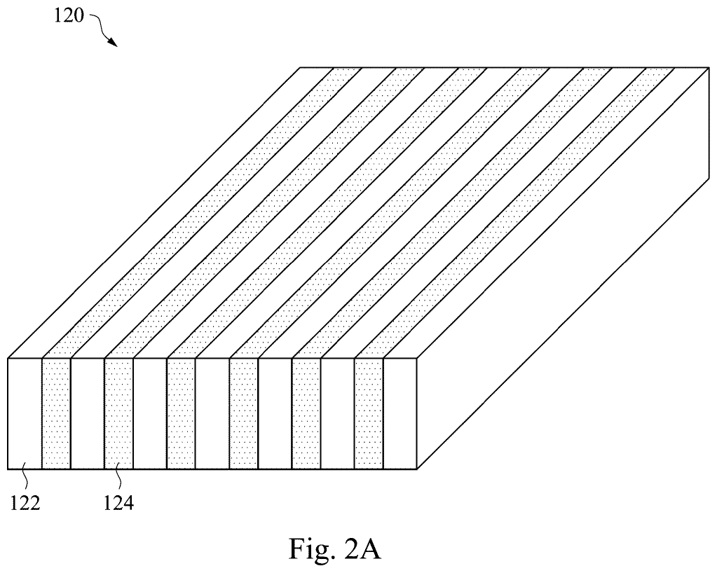

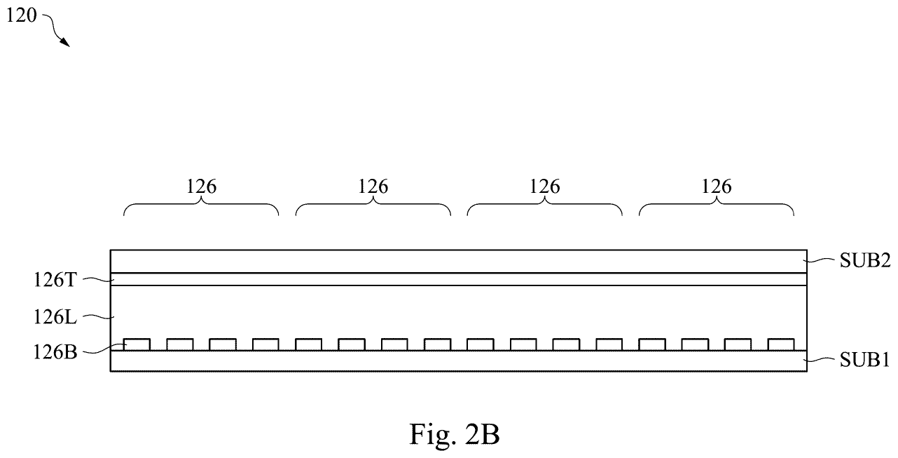

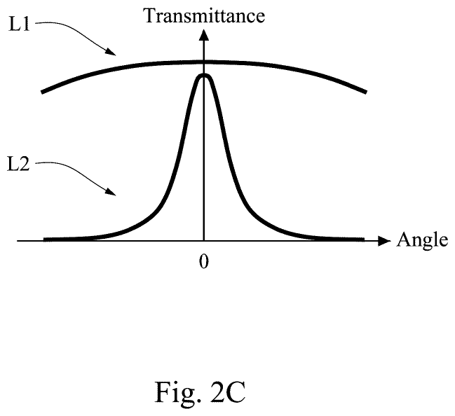

FIG. 2A is a schematic cross-sectional view of an example of a viewing control film 120 according to some embodiments of the disclosure. When the viewing control film 120 is the passive film (e.g., the privacy film), the viewing control film 120 may have transparent portions 122 and shielding portions 124 alternately arranged on a plane orthogonal to the optic axis of the liquid crystal display panel DP. The shielding portions 124 may absorb lights in visible spectrum, and the transparent portions 122 may transmit lights in visible spectrum. With the configuration, off-axis light would be absorbed by the shielding portions 124, while on-axis light would pass the transparent portions 122.

FIG. 2B is a schematic cross-sectional view of an example of a viewing control film 120 according to some embodiments of the disclosure. When the viewing control film 120 is the active film (e.g., the liquid crystal angular attenuator filter), the viewing control film 120 may include plural active elements 126 capable of controlling the direction of light, for example, by collimating light to be on-axis. In such embodiments, the viewing control film 120 may include plural electrically-tunable liquid crystal cells/lens, which are arranged in a one-dimensional or two-dimensional array. As shown in FIG. 2B, each of the plural active elements 126 may include one or more bottom electrodes 126B, a top electrode 126T, and a liquid crystal layer 126L between the bottom electrode 126B and the top electrode 126T. The bottom electrode 126B and/or the top electrode 126T of the active elements 126 can be individually controlled by appropriate circuits, thereby individually controlling orientations of liquid crystal molecule of the liquid crystal layers 126L, such that the light can be substantially collimated. The viewing control film 120 may include optical films/substrates SUB1 and SUB2 for supporting the elements therein.

FIG. 2C illustrates light intensity versus angle of a light before and after passing a viewing control film 120. Reference is made to both FIG. 1 and FIG. 2C. FIG. 2C shows the light L1 output from the light-providing surface 110S is substantially Lambertian in distribution. In FIG. 2C, the light L1 output from the light-providing surface 110S is adjusted by the viewing control film 120, and referred to as light L2 thereafter. After passing the viewing control film 120, the adjusted light L2 may act like uniform collimated/parallel light. The adjusted light L2 may have a major angle with respect to the optic axis. In the present embodiments where the determined angle of the viewing control film 120 is about 0 degree with respect to the optic axis, the adjusted light L2 have the major angle at about 0 degree with respect to the optic axis.

Reference is made back to FIG. 1. The light redirecting film 130 is between the viewing control film 120 and the liquid crystal display panel DP. The light redirecting film 130 is configured to concentrate and redirect light L2 from the backlight module 110 and the viewing control film 120 to a target region TR outside the display device 100, thereby enhancing image brightness and quality. After passing the light redirecting film 130, the concentrated light is referred to as light L3 thereafter. Target region TR may indicate a location of eyes of viewer(s). Target region TR may be referred to as an eye box. The light redirecting film 130 is a component that can transmit, refract and diffract light, rather than absorb light. For example, the light redirecting film 130 is a Fresnel lens film, a micro-lens array, a liquid crystal lens, a geometric phase lens, or the like. In the present embodiments, the target region TR is on an optic axis (or a center axis) DPO of the liquid crystal display panel DP. In some alternative embodiments, the target region TR is offset from an optic axis (or a center axis) DPO of the liquid crystal display panel DP depending on the device requirement. For various applications, additional components may be added between the target region TR and the liquid crystal display panel DP, and the components are omitted in the drawings.

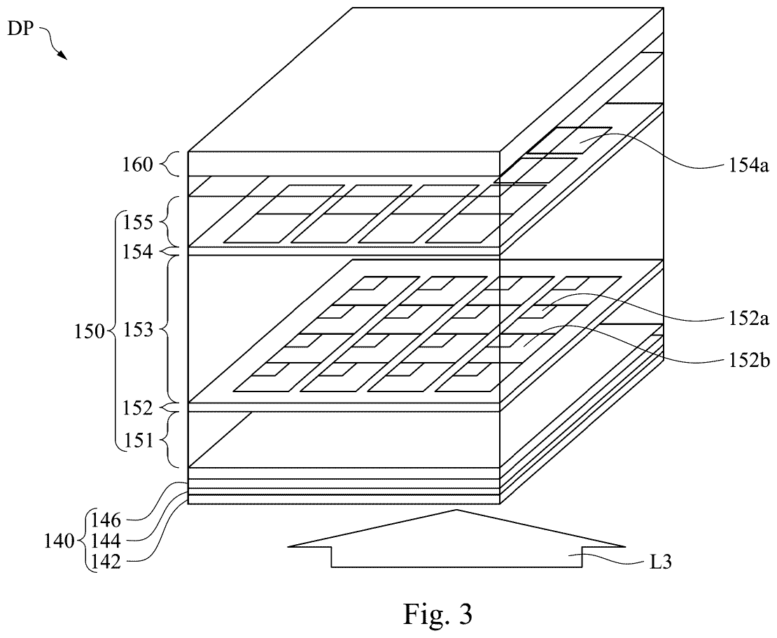

The liquid crystal display panel DP includes a main body 150 including liquid crystal layer 153 (referring to FIG. 3), a first polarizer 140, and a second polarizer 160. The first polarizer 140 may be at a first side of the main body 150 facing the backlight module 110. The second polarizer 160 may be at a second side of the main body 150 facing away from the backlight module 110.

In some embodiments of the present disclosure, the first polarizer 140 is an absorptive polarizer, also referred to as a dichroic polarizer. The absorptive polarizer can effectively absorb ineffective polarized light, thereby reducing ineffective light reflection in the entire device. For example, the first polarizer 140 has have an absorption axis and a transmittance axis orthogonal to the absorption axis. The first polarizer 140 may have an absorbance ranging from about 80% to about 100% at the absorption axis, and a high transmittance at the transmittance axis. Through the configuration, absorptive components (e.g., the absorptive viewing control film 120) in the device are prevented from being heated up by absorbing light energy.

In some embodiments, the liquid crystal display panel DP is exposed directly to a surrounding environment, which can have a lower temperature than a temperature inside the display device 100. Through the configuration, the heat absorbed by the first polarizer 140 can be dissipated to the environment effectively.

In some embodiments, the first and second polarizers 140 and 160 are respectively attached to the first and second side of the main body 150 of the liquid crystal display panel DP (e.g., the first substrate 151 and the second substrate 155 in FIG. 3). In such embodiments, the liquid crystal display panel DP is exposed directly to the surrounding environment, and therefore heat absorbed by the first polarizer can be dissipated to environment directly, thereby enhancing heat dissipation. In some embodiments, the first polarizer 140 may be attached to the first side of the main body 150 of the liquid crystal display panel DP (e.g., the first substrate 151 in FIG. 3), and the second polarizer 160 may be spaced apart from the main body 150 of the liquid crystal display panel DP. In some other embodiments, both the first and second polarizers 140 and 160 are spaced apart from the main body 150 of the liquid crystal display panel DP.

The second polarizer 160 can be any suitable polarizers. For example, the second polarizer 160 is a reflective polarizer an absorptive polarizer. In some embodiments, the first and second polarizers 140 and 160 are both absorptive polarizers. In some embodiments where the first and second polarizers 140 and 160 are absorptive polarizers, they may have a same thickness/material/structure of absorptive polarizers. Alternatively, in some embodiments where the first and second polarizers 140 and 160 are absorptive polarizers, they may have different thickness/material/structures of absorptive polarizers. In some embodiments, the first and second polarizers 140 and 160 are an absorptive polarizer and a reflective polarizer, respectively. In such embodiments, they may have different thickness/material/structures of absorptive and reflective polarizers.

FIG. 3 is a schematic view of a liquid crystal display panel DP of the display device of FIG. 1. Reference is made to both FIGS. 1 and 3. The liquid crystal display panel DP may include the first polarizer 140, a main body 150, and the second polarizer 160. The main body 150 of the liquid crystal display panel DP may include a first substrate 151, an active device array layer 152, the liquid crystal layer 153, a color filter layer 154, a second substrate 155. Some elements of the liquid crystal display panel DP may be omitted. And, additional elements can be involved in the liquid crystal display panel DP.

In some embodiments, the first and second polarizers 140 and 160 are linear polarizers. For example, the absorptive polarizer 140 may include a triacetate cellulose (TAC) film 142, a polyvinyl alcohol (PVA) polarizing element 144, TAC film 146, in which the TAC films 142 and 146 are transparent optical films, and the PVA polarizing element 144 may have a transmission axis and an absorption axis by stretching. In some alternative embodiments, the first and second polarizers 140 and 160 may be circular polarizers or other suitable polarizers.

The liquid crystal layer 153 is sandwiched between the first substrate 151 and the second substrate 155. In some embodiments, surfaces of the first substrate 151 and the second substrate 155 adjacent to the liquid crystal layer 153 may be surface treated for provide an initial orientation of liquid crystal molecules in the liquid crystal layer 153. For example, horizonal and/or vertical alignment layers may be coated over the surfaces of the first substrate 151 and the second substrate 155 adjacent to the liquid crystal layer 153.

In some embodiments, the active device array layer 152 is between the liquid crystal layer 153 and the first substrate 151. In some embodiments, the active device array layer 152 is between the liquid crystal layer 153 and the first polarizer 140. The active device array layer 152 includes plural active devices 152a and pixel electrodes 152p electrically coupled to the active devices 152a. The position of the active device array layer 152 in the liquid crystal display panel DP may vary according to design requirement. In some embodiments, the liquid crystal display panel DP may include a counter electrode layer between the liquid crystal layer 153 and the second substrate 155, and the active device array layer 152 and the counter electrode layer may provide a suitable electric field for controlling the orientation of liquid crystal molecules in the liquid crystal layer 153.

The color filter layer 154 may between the liquid crystal layer 153 and the second substrate 155. The color filter layer 154 may be at the second side of the liquid crystal layer 153 facing away from the backlight module 110. The color filter layer 154 may include plural color filters 154a respectively corresponding to the pixel electrodes 152p. The position of the color filter layer 154 in the liquid crystal display panel DP may vary according to design requirement. In some other embodiments, the color filter layer 154 can be omitted.

By controlling the electric field across the liquid crystal layer 153, and by providing a suitable alignment to control the initial orientation of liquid crystal molecules in the liquid crystal layer 153, the liquid crystal display panel DP may operate for electrically controlled birefringence (ECB) display, twist-nematic (TN) display, vertical-alignment (VA) display, multi-domain vertical alignment (MVA) display, or in-plane switching (IPS) display.

According to some embodiments of the present disclosure, an absorptive polarizer is attached to a side of the liquid crystal display panel facing the backside module. The absorptive polarizer may replace a reflective polarizer or an advanced polarization conversion film in the display device. The absorptive polarizer can effectively absorb ineffective polarized light. Through the configuration, the light reflection in the entire device can be reduced, thereby prevent components (e.g., the absorptive viewing control film 120) from heating up by absorbing light energy, which can improve the light-emitting efficiency of the entire display device.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A liquid crystal display device, comprising:
a backlight module configured to provide a light;
a liquid crystal display panel, comprising a liquid crystal layer, a first polarizer at a first side of the liquid crystal layer facing the backlight module, and a second polarizer at a second side of the liquid crystal layer facing away from the backlight module, wherein the first polarizer is an absorptive polarizer;
a viewing control film between the backlight module and the liquid crystal display panel and configured to limit an angle of the light; and
a light redirecting film between the viewing control film and the liquid crystal display panel and configured to redirect the light from the viewing control film to a target region.

2. The liquid crystal display device of claim 1, wherein the second polarizer is a reflective polarizer.

3. The liquid crystal display device of claim 1, wherein the second polarizer is another absorptive polarizer.

4. The liquid crystal display device of claim 1, wherein the angle limited by the viewing control film is in a range from about-30 degrees to about 30 degrees.

5. The liquid crystal display device of claim 1, wherein the angle limited by the viewing control film is in a range from about-10 degrees to about 10 degrees.

6. The liquid crystal display device of claim 1, wherein the viewing control film is a privacy film.

7. The liquid crystal display device of claim 1, wherein an off-axis absorbance of the viewing control film is greater than an on-axis absorbance of the viewing control film.

8. The liquid crystal display device of claim 1, wherein the viewing control film is a liquid crystal angular attenuator filter.

9. The liquid crystal display device of claim 1, wherein the liquid crystal display panel further comprises an active device array layer between the liquid crystal layer and the first polarizer, wherein the active device array layer comprises a plurality of active devices and a plurality of pixel electrodes electrically coupled to the active devices.

10. The liquid crystal display device of claim 1, wherein the liquid crystal display panel further comprises a color filter layer at the second side of the liquid crystal layer facing away from the backlight module.

11. The liquid crystal display device of claim 1, wherein the light provided by the backlight module scatters.

12. The liquid crystal display device of claim 1, wherein the light redirecting film is a Fresnel lens.

13. The liquid crystal display device of claim 1, wherein the light redirecting film is a micro-lens array.

14. The liquid crystal display device of claim 1, wherein the light redirecting film is a liquid crystal lens.

15. The liquid crystal display device of claim 1, wherein the light redirecting film is a geometric phase lens.
